(19) United States
(12) Patent Application Publication
(10) Pub. No.: US 2022/0212081 A1
(43) Pub. Date: Jul. 7, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TAKASHI KUBODERA, TOKYO (JP)

(21) Appl. No.: 17/430,427

(22) PCT Filed: Feb. 21, 2019
(86) PCT No.: PCT/JP2019/006516

§ 371 Date: Aug. 12, 2021

(51) Int. Cl. A63B 69/36

(52) U.S. Cl. CPC A63B 69/3632; A63B 2220/803

(57) ABSTRACT

To provide an information processing apparatus, an information processing method, and a program that can detect a practice swing on the basis of sensor data from a motion sensor. An information processing apparatus includes a control section executing processing for detecting, on the basis of sensor data detected by a motion sensor provided on an object, that a practice swing has been performed with the object. The object includes a grip portion. Assuming that an X axis is a straight line parallel to an axis of the grip portion and that a Y axis runs straight to the X axis, the sensor data includes an angular velocity of the object in a Y axis direction. The control section detects that the practice swing has been performed in a case where the angular velocity of the object in the Y axis direction changes from positive to negative.

### TECHNICAL FIELD

The present disclosure relates to an information processing apparatus, an information processing method, and a program.

### BACKGROUND ART

Conventionally, there has been disclosed that swing analysis of a swing is executed by using a motion sensor to detect an impact (moment of a hit) caused by hitting of a ball.

Additionally, PTL 1 listed below discloses a detection method in which, on the basis of data obtained from a camera capturing an image of a moving trajectory in which a hitting portion of equipment passes through a preset impact position, in addition to data from a motion sensor measuring a physical amount at the hitting portion, an output corresponding to the impact position can be identified even in a practice swing in which a ball is not actually hit.

### CITATION LIST

### Patent Literature

### [PTL 1]

JP 2017-170078A

### SUMMARY

### Technical Problems

However, in the related art, in a case where a mere practice swing that involves no actual hit is detected, concurrent use of a motion sensor attached to the equipment and a laser, a camera, and the like to monitor the hitting portion is necessary, leading to a need for an additional facility. Additionally, the camera to be added needs to recognize the head and thus to be installed very close to the impact expected position, leading to difficulty in fitting the entire body of a user within an angle of view.

### Solution to Problems

The present disclosure proposes an information processing apparatus including a control section executing processing for detecting, on the basis of sensor data detected by a motion sensor provided on an object, that a practice swing has been performed with the object. The object includes a grip portion. Assuming that an X axis is a straight line parallel to an axis of the grip portion and that a Y axis runs straight to the X axis, the sensor data includes an angular velocity of the object in a Y axis direction. The control section detects that the practice swing has been performed in a case where the angular velocity of the object in the Y axis direction changes from positive to negative.

The present disclosure proposes an information processing method including executing, by a processor, processing for detecting, on the basis of sensor data detected by a motion sensor provided on an object, that a practice swing has been performed with the object. The object includes a grip portion. Assuming that an X axis is a straight line parallel to an axis of the grip portion and that a Y axis runs straight to the X axis, the sensor data includes an angular velocity of the object in a Y axis direction. The method further includes detecting that the practice swing has been performed in a case where the angular velocity of the object in the Y axis direction changes from positive to negative.

The present disclosure proposes a program causing a computer to function as a control section executing processing for detecting, on the basis of sensor data detected by a motion sensor provided on an object, that a practice swing has been performed with the object. The object includes a grip portion. Assuming that an X axis is a straight line parallel to an axis of the grip portion and that a Y axis runs straight to the X axis, the sensor data includes an angular velocity of the object in a Y axis direction. The control section detects that the practice swing has been performed in a case where the angular velocity of the object in the Y axis direction changes from positive to negative.

### BRIEF DESCRIPTION OF DRAWINGS

FIG. 1 is a diagram illustrating an outline of a practice swing detection system according to an embodiment of the present disclosure.

FIG. 2 is a block diagram depicting an example of a configuration of a sensor apparatus and a display apparatus according to the present embodiment.

FIG. 3 is a diagram illustrating motion of a head during a golf swing according to the present embodiment.

FIG. 4 is a flowchart depicting an example of an overall flow of practice swing detection processing according to the present embodiment.

FIG. 5 is a diagram depicting an example of measurement data regarding an angular velocity in practice swing detection according to the present embodiment.

### DESCRIPTION OF EMBODIMENT

A preferred embodiment of the present disclosure will be described below in detail with reference to the accompanying drawings. Note that, in the specification and the drawings, duplicate description of components having substantially the same functional configurations is omitted by assigning the same reference signs to the components.

Additionally, the description will be given in the following order.

1. Outline of Practice Swing Detection System according to Embodiment of Present Disclosure

2. Configuration Example

3. Operation Processing

4. Conclusion

### <1. Outline of Practice Swing Detection System According to Embodiment of Present Disclosure>

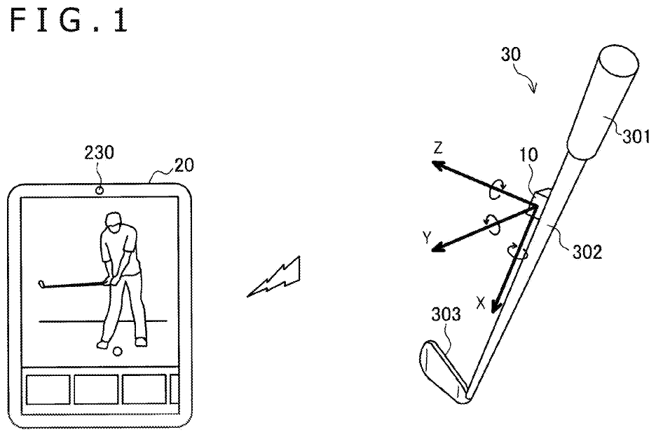

FIG. 1 is a diagram illustrating an outline of a practice swing detection system according to an embodiment of the present disclosure. As depicted in FIG. 1, the practice swing detection system according to the present embodiment detects, on the basis of sensor data detected by a sensor apparatus 10 attached to equipment (object), that practice swing has been performed with the equipment. The practice swing detection processing may be executed either by the sensor apparatus 10 or by a display apparatus 20 having received sensor data from the sensor apparatus 10.

In the present embodiment, by using a specific change in angular velocity of the equipment particularly in a golf swing, a practice swing can be detected by using only a motion sensor. The details of practice swing detection based on a change in angular velocity will be described below.

Additionally, as depicted in FIG. 1, the equipment corresponding to an object of practice swing detection may be, for example, a golf club 30 including a grip 301 (grip portion) 301, a shaft 302 extended on the same axis as that of the grip 301, and a head (hitting portion) 303 provided at a tip of the shaft 302. Additionally, the equipment need not necessarily include all of the grip 301, the shaft 302, and the head 303, but may be, for example, equipment for golf swing practice (for practice swing) including the grip 301 and the shaft 302 without the head 303 or equipment including only the grip 301.

Additionally, in the present embodiment, a practice swing can be detected by using only the sensor apparatus 10 attached to the equipment, and thus a camera 230 of the display apparatus 20 implemented by, for example, a smartphone, a tablet terminal, or the like can capture an image of motion of the whole body of a user during practice swing operation with the whole body of the user fitted in an angle of view (the camera used may be a front camera or a rear camera). In this case, the display apparatus 20 can clip a moving image of a practice swing according to the timing of detection of the practice swing and save and display the moving image. Additionally, the display apparatus 20 can calculate a head speed, a face angle, and the like on the basis of acceleration or an angular velocity at the timing of detection of the practice swing, and present the head speed, the face angle, and the like in addition to the moving image.

In addition, the sensor apparatus 10 or the display apparatus 20 may implement a technique for detecting an impact by using a change in acceleration or angular velocity when a ball is actually hit with the equipment. The sensor apparatus 10 or the display apparatus 20 may execute the practice swing detection processing according to the present embodiment when the “practice swing” is selected in a menu screen.

The outline of the practice swing detection system according to the embodiment of the present disclosure has been described. Now, specific configurations of apparatuses included in the practice swing detection system according to the present embodiment will be described with reference to the drawings.

### <2. Configuration Example>

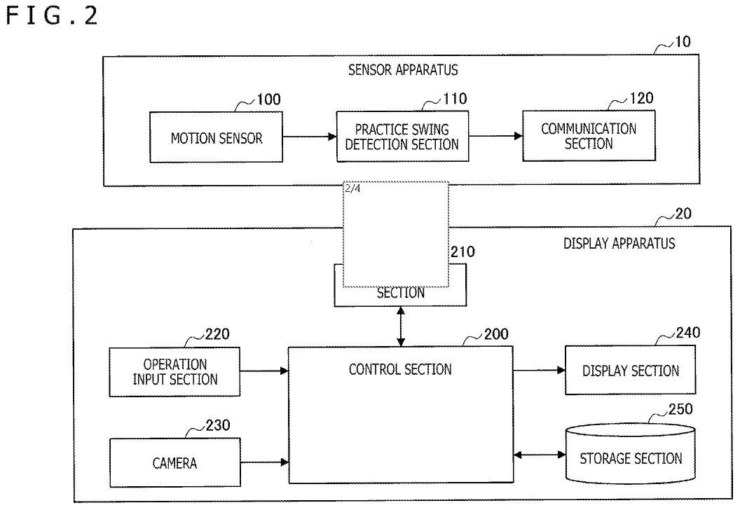

FIG. 2 is a block diagram depicting an example of a configuration of the sensor apparatus 10 and the display apparatus 20 according to the present embodiment.

### (Configuration of Sensor Apparatus 10)

As depicted in FIG. 2, the sensor apparatus 10 includes a motion sensor 100, a practice swing detection section 110, and a communication section 120. The sensor apparatus 10 is installed on the golf club 30. The sensor apparatus 10 may be removably attached to the golf club 30.

The motion sensor 100 is a sensor that can measure an angular velocity around each of three axes. Additionally, the motion sensor 100 can also measure acceleration in each of the axial directions of the three axes.

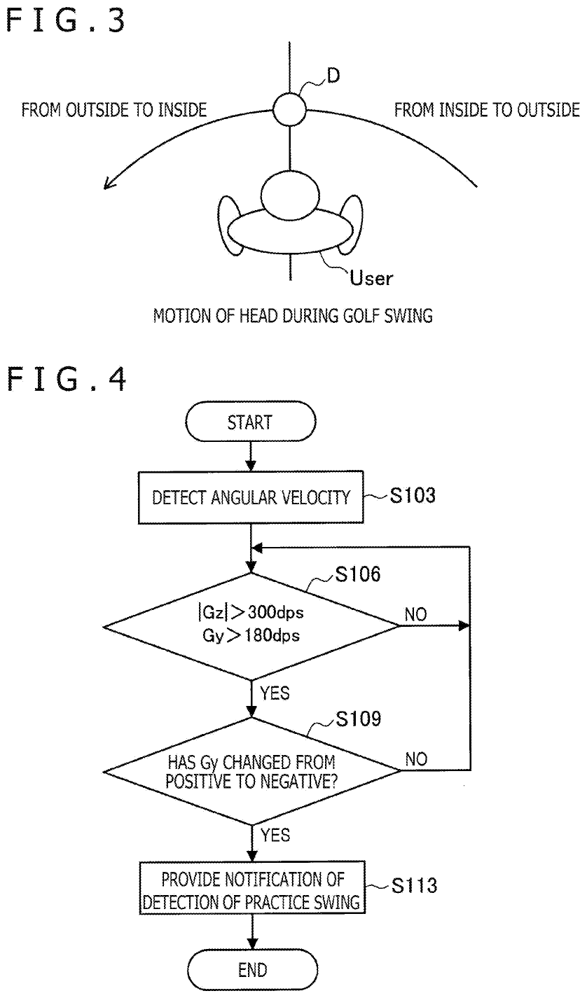

The practice swing detection section 110 detects, on the basis of the angular velocity measured by the motion sensor 100, whether or not a practice swing has been performed with the golf club 30. As depicted in FIG. 3, motion (moving trajectory) of the head 303 during a golf swing moves, at the time of swing-down toward a lowest point D, from inside, which is close to the body of the user, toward outside in a case where the user is viewed from above. Then, after passing through the lowest point, the head 303 moves from outside toward inside. In such a manner, a moving direction of the head 303 is switched near the lowest point, and thus the sign of the angular velocity is changed near the lowest point. The practice swing detection section 110 according to the present embodiment may perform practice swing detection by using the characteristic of the angular velocity in such a golf swing as described above. Note that the specific processing contents of practice swing detection according to the present embodiment will be described below.

A detection result is transmitted to the display apparatus 20 by the communication section 120. The communication section 120 is connected, in a wired or wireless manner, to the display apparatus 20 for communication, and transmits and receives data to and from the display apparatus 20. The communication section 120 is connected to the display apparatus 20 for communication by, for example, wired/wireless LAN (Local Area Network), or Wi-Fi (registered trademark), Bluetooth (registered trademark), a cellular communication network (LTE (Long Term Evolution), 3G (third generation of wireless mobile telecommunication scheme), or the like.

### (Configuration of Display Apparatus 20)

As depicted in FIG. 2, the display apparatus 20 includes a control section 200, a communication section 210, an operation input section 220, a camera 230, a display section 240, and a storage section 250. The display apparatus 20 is, for example, an information processing terminal such as a smartphone, a tablet terminal, a cellular phone terminal, a notebook PC, or a digital camera. For example, an application operating in conjunction with the sensor apparatus 10 according to the present embodiment is installed in the display apparatus 20. The application may provide a notification of a detection result by the sensor apparatus 10 or may execute analysis processing for sensor data measured by the sensor apparatus 10. Additionally, the display apparatus 20 may capture an image of a golf swing of the user and execute display and save processing for a golf swing video in conjunction with the sensor apparatus 10. A specific configuration will be described below.

The control section 200 functions as an arithmetic processing apparatus and a control apparatus to control operations in general within the display apparatus 20 according to various programs. The control section 200 is implemented by, for example, an electronic circuit such as a CPU (Central Processing Unit) or a microprocessor. Additionally, the control section 200 may include a ROM (Read Only Memory) storing programs, arithmetic parameters, and the like that are to be used, and a RAM (Random Access Memory) temporarily storing parameters varying as appropriate.

Additionally, in a case of capturing an image of a golf swing of the user with use of the camera 230 and receiving a detection notification of detection of a practice swing from the sensor apparatus 10, the control section 200 according to the present embodiment may execute processing for clipping a video of a certain duration including an amount of time before and after the practice swing and saving the video as a practice swing video. In the present embodiment, practice swing detection can be performed on the basis of the angular velocity detected by the sensor apparatus 10 installed on the golf club 30, and thus the camera 230 can be used to capture an image with a wide angle of view that covers the entire swing of the user. Additionally, also in a case of receiving an impact detection notification indicating that the impact of actual hitting of a ball has been detected, the control section 200 may execute processing for clipping a video of a certain duration including an amount of time before and after the impact and saving the video as a video of a hit.

Additionally, the system according to the present embodiment is configured, as an example, to execute the practice swing detection processing in the sensor apparatus 10. However, the present disclosure is not limited, and, for example, the control section 200 of the display apparatus 20 may detect a practice swing on the basis of three-axis angular velocity data received from the sensor apparatus 10.

The communication section 210 is connected, in a wired or wireless manner, to the sensor apparatus 10 for communication and transmits and receives data to and from the sensor apparatus 10. The communication section 210 is connected to the sensor apparatus 10 for communication by, for example, wired/wireless LAN (Local Area Network), or Wi-Fi (registered trademark), Bluetooth (registered trademark), a cellular communication network (LTE (Long Term Evolution), 3G (third generation of wireless mobile telecommunication scheme), or the like.

The operation input section 220 receives an operation instruction from the user and outputs the contents of the operation to the control section 200. The operation input section 220 may be a touch sensor, a pressure sensor, or a proximity sensor (capacitive sensor or the like) provided integrally with the display section 240. Alternatively, the operation input section 220 may have a physical configuration that is provided separately from the display section 240 and that includes buttons, switches, or the like.

The camera 230 includes a lens system including an image capturing lens, a diaphragm, a zoom lens, a focus lens, and the like, a driving system causing a focus operation or a zoom operation to be performed on the lens system, and a solid state image sensor array photoelectrically converting imaging light obtained by the lens system to generate an imaging signal, and the like. The solid state image sensor array may be implemented by, for example, a CCD (Charge Coupled Device) sensor array or a CMOS (Complementary Metal Oxide Semiconductor) sensor array.

The display section 240 is a display apparatus that outputs notification information, operation screens, menu screens, videos of golf swings, analysis results, and the like. The display section 240 may be, for example, a display apparatus such as a liquid crystal display (LCD) or an organic EL (Electroluminescence) display.

The storage section 250 is implemented by a ROM (Read Only Memory) storing programs, arithmetic parameters, and the like used by the control section 200 for processing, and a RAM (Random Access Memory) temporarily storing parameters varying as appropriate and the like. For example, the storage section 250 may store a video of a golf swing of the user captured by the camera 230, sensor data measured by the sensor apparatus 10c, analysis results for the sensor data, and the like.

The configurations of the apparatuses according to the present embodiment have been specifically described but are not limited to the example depicted in FIG. 2.

### <3. Operation Processing>

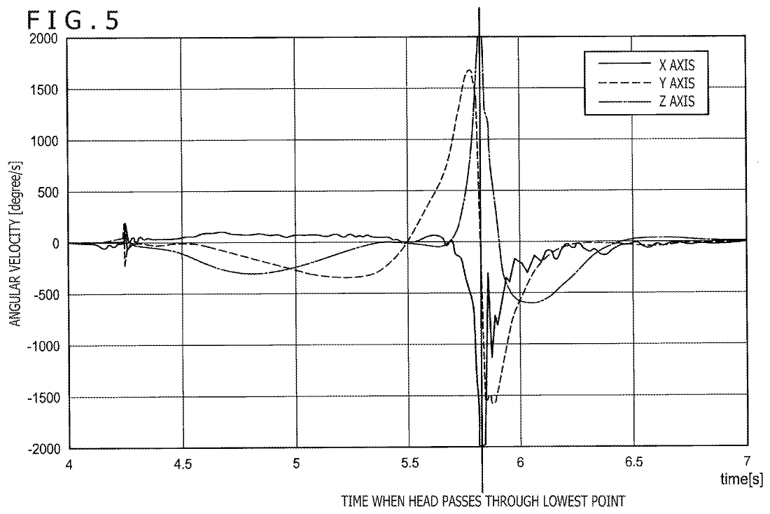

Now, the practice swing detection processing according to the present embodiment will be specifically described with reference to FIG. 4. FIG. 4 is a flowchart depicting an example of an overall flow of the practice swing detection processing according to the present embodiment.

As depicted in FIG. 4, first, the sensor apparatus 10 (example of the information processing apparatus) provided on the golf club 30 detects the angular velocity using the motion sensor 100 (step S103). In a case described below as an example, the sensor apparatus 10 assumes that, as depicted in FIG. 1, for example, an X axis is a straight line parallel to the axes of the grip 301 and the shaft 302, that a Y axis is an axis (face direction of the head 303) running straight to the X axis, and that a Z axis is a straight line in a direction running straight to a surface including the X axis and the Y axis, and the sensor apparatus 10 is used to measure the angular velocity around each of the axes.

Then, the practice swing detection section 110 determines whether or not a Z axis component of the angular velocity (that is, the angular velocity in the Z axis direction) has an absolute value exceeding a predetermined value (threshold) and whether or not a Y axis component of the angular velocity (that is, the angular velocity in the Y axis direction) exceeds a predetermined value (threshold) (step S106). For the value of the Z axis component, the sign of the Z axis component is inverted for a left-handed user, and thus, it is preferable that, as an example, an absolute value is taken for determination.

Now, FIG. 5 depicts an example of measurement data regarding the angular velocity the in practice swing detection according to the present embodiment. As depicted in FIG. 5, when the head of the golf club 30 passes through the lowest point in a swing, the sign of the Y axis component changes (from positive to negative). Immediately before this, the user performs an operation of swing up the golf club 30, and thus, a large amplitude occurs in the Z axis component. Additionally, a somewhat large amplitude is observed in the Y axis component. Thus, in the present embodiment, as an example, whether or not an amplitude exceeding a predetermined value has occurred in the Z axis component and the Y axis component of the angular velocity is determined as pre-processing for the practice swing detection, and thus the operations other than the practice swing are excluded, enabling misdetection to be prevented. Note that, in the example depicted in FIG. 4, whether or not amplitudes exceeding the respective predetermined values have occurred in the Z axis component and the Y axis component of the angular velocity is determined, but that the present disclosure is not limited to this and whether or not an amplitude exceeding the predetermined value has occurred in at least one of the axis components may be determined. In that case, as an example, whether or not an amplitude exceeding a predetermined value has occurred in the Z axis component is preferably determined. Additionally, although each predetermined value is not particularly limited, as an example, whether or not the Z axis component has an absolute value of 300 degrees/second or whether or not the Y axis component exceeds 180 degrees/second may be determined, for example. In addition, as an example, the predetermined value of the Z axis component is preferably set larger than the predetermined value for the Y axis component.

Then, in a case where amplitudes exceeding the respective predetermined values have occurred in the Z axis component and the Y axis component of the angular velocity (step S106/Yes), the practice swing detection section 110 determines whether or not the sign of the Y axis component has changed from positive to negative (step S109).

Then, in a case where the sign of the Y axis component has changed from positive to negative (step S109/Yes), the practice swing detection section 110 detects that a practice swing has been performed with the golf club 30 and, for example, provides a detection notification of detection of a practice swing to the display apparatus 20 (step S113).

The example of the operation processing according to the present embodiment will be described below. Note that the operation processing depicted in FIG. 4 is an example and that the present embodiment is not limited to this. For example, of the operation processing depicted in FIG. 4, the processing depicted at steps S106 to S113 may be executed by the control section 200 of the display apparatus 20 (example of the information processing apparatus) having received sensor data from the sensor apparatus 10.

Additionally, the pre-processing for the practice swing detection depicted at step S106 is executed to increase the accuracy of the practice swing detection. However, the present embodiment is not limited to this, and practice swing detection may be performed simply by post-processing for the practice swing detection depicted at step S109.

### <4. Conclusion>

As described above, the information processing system according to the present disclosure enables practice swing detection on the basis of sensor data from the motion sensor.

The preferred embodiment of the present disclosure has been described in detail with reference to the accompanying drawings. However, the present technique is not limited to such an example. It is obvious that any person who has ordinary knowledge in the technical field to which the present disclosure belongs can conceive of various changes or modifications without departing from the technical idea set forth in the claims, and it should be understood that these changes and modifications naturally fall within the technical scope of the present disclosure.

For example, a computer program that causes hardware such as a CPU, a ROM, or a RAM which is built in the sensor apparatus 10 or the display apparatus 20 described above to implement the function of the sensor apparatus 10 or the display apparatus 20 can be created. Alternatively, a computer-readable storage medium in which the computer program is stored is provided.

Additionally, the effects described herein are only descriptive or illustrative and are not restrictive. In other words, the technique according to the present disclosure may produce, in addition to or instead of the effects described above, other effects that are obvious to a person having ordinary skill in the art from the descriptions in the present specification.

Note that the present technique can also take configurations described below.

(1)

An information processing apparatus including:

a control section executing processing for detecting, on the basis of sensor data detected by a motion sensor provided on an object, that a practice swing has been performed with the object,

in which the object includes a grip portion,

assuming that an X axis is a straight line parallel to an axis of the grip portion and that a Y axis runs straight to the X axis, the sensor data includes an angular velocity of the object in a Y axis direction, and

the control section detects that the practice swing has been performed in a case where the angular velocity of the object in the Y axis direction changes from positive to negative.

(2)

The information processing apparatus according to (1) described above, in which the control section detects that the practice swing has been performed in a case where the angular velocity of the Y axis changes from positive to negative after exceeding a predetermined value.

(3)

The information processing apparatus according to (1) or (2) described above,

in which the sensor data includes an angle of a Z axis in a direction running straight to a surface including the X axis and the Y axis, and

the control section further detects that the practice swing has been performed in a case where the angular velocity in the Y axis direction changes from positive to negative after the angle of the Z axis exceeds a predetermined value.

(4)

The information processing apparatus according to (3) described above, in which the control section detects that the practice swing has been performed in a case where the angular velocity in the Y axis direction exceeds a first predetermined value and where the angular velocity of the Y axis changes from positive to negative after the angle of the Z axis exceeds a second predetermined value larger than the first predetermined value.

(5)

The information processing apparatus according to any one of (1) to (4) described above,

in which the object includes a shaft extending on an axis identical to an axis of the grip portion, and

it is assumed that the X axis is a straight line parallel to the shaft.

(6)

The information processing apparatus according to (5) described above, in which the object is a golf club including a head that is provided at a tip of the shaft and that includes a face.

(7)

The information processing apparatus according to any one of (1) to (6) described above, in which the information processing apparatus is a sensor apparatus removably provided on the object.

(8)

The information processing apparatus according to any one of (1) to (6) described above, further including:

a reception section that receives the sensor data from a sensor apparatus attached to the object; and

a display section.

(9)

An information processing method including:

executing, by a processor, processing for detecting, on the basis of sensor data detected by a motion sensor provided on an object, that a practice swing has been performed with the object,

in which the object includes a grip portion, and

assuming that an X axis is a straight line parallel to an axis of the grip portion and that a Y axis runs straight to the X axis, the sensor data includes an angular velocity of the object in a Y axis direction,

the method further including detecting that the practice swing has been performed in a case where the angular velocity of the object in the Y axis direction changes from positive to negative.

(10)

A program causing a computer to function as:

a control section executing processing for detecting, on the basis of sensor data detected by a motion sensor provided on an object, that a practice swing has been performed with the object,

in which the object includes a grip portion,

assuming that an X axis is a straight line parallel to an axis of the grip portion and that a Y axis runs straight to the X axis, the sensor data includes an angular velocity of the object in a Y axis direction, and

the control section detects that the practice swing has been performed in a case where the angular velocity of the object in the Y axis direction changes from positive to negative.

### REFERENCE SIGNS LIST

10: Sensor apparatus

20: Display apparatus

30: Golf club

100: Motion sensor

110: Practice swing detection section

120: Communication section

200: Control section

210: Communication section

220: Operation input section

230: Camera

240: Display section

250: Storage section

301: Grip (grip portion)

302: Shaft

303: Head (hitting portion)

1. An information processing apparatus comprising:
a control section executing processing for detecting, on a basis of sensor data detected by a motion sensor provided on an object, that a practice swing has been performed with the object,
wherein the object includes a grip portion,
assuming that an X axis is a straight line parallel to an axis of the grip portion and that a Y axis runs straight to the X axis, the sensor data includes an angular velocity of the object in a Y axis direction, and
the control section detects that the practice swing has been performed in a case where the angular velocity of the object in the Y axis direction changes from positive to negative.

2. The information processing apparatus according to claim 1, wherein the control section detects that the practice swing has been performed in a case where the angular velocity of the Y axis changes from positive to negative after exceeding a predetermined value.

3. The information processing apparatus according to claim 1,
wherein the sensor data includes an angle of a Z axis in a direction running straight to a surface including the X axis and the Y axis, and
the control section further detects that the practice swing has been performed in a case where the angular velocity in the Y axis direction changes from positive to negative after the angle of the Z axis exceeds a predetermined value.

4. The information processing apparatus according to claim 3, wherein the control section detects that the practice swing has been performed in a case where the angular velocity in the Y axis direction exceeds a first predetermined value and where the angular velocity of the Y axis changes from positive to negative after the angle of the Z axis exceeds a second predetermined value larger than the first predetermined value.

5. The information processing apparatus according claim 1,
wherein the object includes a shaft extending on an axis identical to an axis of the grip portion, and
it is assumed that the X axis is a straight line parallel to the shaft.

6. The information processing apparatus according to claim 5, wherein the object is a golf club including a head that is provided at a tip of the shaft and that includes a face.

7. The information processing apparatus according to claim 1, wherein the information processing apparatus is a sensor apparatus removably provided on the object.

8. The information processing apparatus according to claim 1, further comprising:
a reception section that receives the sensor data from a sensor apparatus attached to the object; and
a display section.

9. An information processing method comprising:
executing, by a processor, processing for detecting, on a basis of sensor data detected by a motion sensor provided on an object, that a practice swing has been performed with the object,
wherein the object includes a grip portion, and,
assuming that an X axis is a straight line parallel to an axis of the grip portion and that a Y axis runs straight to the X axis, the sensor data includes an angular velocity of the object in a Y axis direction,
the method further including detecting that the practice swing has been performed in a case where the angular velocity of the object in the Y axis direction changes from positive to negative.

10. A program causing a computer to function as:
a control section executing processing for detecting, on a basis of sensor data detected by a motion sensor provided on an object, that a practice swing has been performed with the object,
wherein the object includes a grip portion,
assuming that an X axis is a straight line parallel to an axis of the grip portion and that a Y axis runs straight to the X axis, the sensor data includes an angular velocity of the object in a Y axis direction, and
the control section detects that the practice swing has been performed in a case where the angular velocity of the object in the Y axis direction changes from positive to negative.
